(19) United States
(12) Patent Application Publication
(10) Pub. No.: US 2005/0019663 A1
(43) Pub. Date: Jan. 27, 2005

(54) Coin-shaped all solid battery

(75) Inventors: Tetsuo Nanno, Osaka (JP); Kanji Takata, Osaka (JP)

Correspondence Address: MCDERMOTT, WILL & EMERY LLP, 600 13th Street, N.W., Washington, DC, 20005-3096, US

(73) Assignee: MATSUSHITA ELECTRIC INDUSTRIAL CO., LTD.

(21) Appl. No.: 10/893,867

(22) Filed: Jul. 20, 2004

(30) Foreign Application Priority Data
Jul. 23, 2003 (JP) JP2003-278226

(51) Int. Cl. H01M 4/80; H01M 2/08; H01M 2/26

(52) U.S. Cl. 429/235; 429/161; 429/174

(57) ABSTRACT

A coin-shaped all solid battery including: (a) a power generating unit including a first electrode, a second electrode and a solid electrolyte interposed therebetween; (b) a metallic case facing to the first electrode to serve as a first electrode terminal; (c) a metallic sealing plate facing to the second electrode to serve as a second electrode terminal; (d) a gasket insulating the metallic case from the metallic sealing plate; and at least one of (e-1) a first conductive layer interposed between the first electrode and the metallic case to be integrated with the first electrode and (e-2) a second conductive layer interposed between the second electrode and the sealing plate to be integrated with the second electrode, wherein the conductive layer includes porous metal and the porous metal includes a molded metal powder.

### BACKGROUND OF THE INVENTION

The present invention relates to a structure of a coin-shaped all solid battery. In particular, it relates to a structure concerning current collection thereof.

Coin-shaped batteries have been used as main power sources or backup batteries for portable devices in various fields. Examples of the coin-shaped batteries include an alkaline button battery, a lithium primary battery, a lithium ion secondary battery and the like. Among them, the lithium ion secondary battery is expected as a promising power source of high operation voltage and high energy density.

The alkaline button battery includes a positive electrode comprising an MnO₂-based mixture, a negative electrode comprising a Zn-based mixture and an electrolyte composed principally of a KOH aqueous solution. In the lithium primary battery, are adopted a positive electrode comprising fluorinated graphite, a negative electrode comprising metallic Li and an electrolyte comprising an organic solvent dissolving Li salt therein. The organic solvent includes carbonic acid ester-based or an ether-based solvent. Further, the lithium ion secondary battery includes a positive electrode comprising a mixture based on MnO₂, Nb₂O₅ and LiCoO₂, a negative electrode comprising Li_{4/3}Ti_{5/3}O4 or carbon and the same electrolyte as used in the lithium primary battery.

FIG. 1 shows a sectional view of a conventional coin-shaped battery.

The coin-shaped battery includes a power generating unit comprising a coin-shaped positive electrode 11, a coin-shaped negative electrode 12 and a separator 13 interposed therebetween. The power generating unit is installed in a metallic case 15 and an opening of the case 15 is sealed with a metallic sealing plate 16. A gasket 17 is arranged around the periphery of the sealing plate 16. The opening end of the case is crimped onto the gasket 17 to seal the case.

As to the coin-shaped battery, an area of the positive and negative electrodes on which they are facing to each other is limited. Further, its structure for collecting electric current from the positive and negative electrodes is also limited because the battery needs to be in the thin form. Therefore, in general, a paste mainly composed of carbon is applied to the inner surface of the case or the sealing plate to increase the contact area between the electrodes and the case or the sealing plate, thereby ensuring the current collection (Japanese Laid-Open Patent Publication No. HEI 5-21075). If metallic Li is used as the negative electrode, the metallic Li is directly press-bonded to the sealing plate and a carbon-based paste 14 is used only on the positive electrode side as shown in FIG. 1.

According to this process, the obtained battery may work satisfactorily immediately after the initiation of the charge/discharge or while the power generating unit held in the case keeps its thickness uniform. However, if the power generating unit varies in volume (expands) or in thickness after repeated charge/discharge, the contact between the electrodes and the carbon-based paste becomes unstable.

Commercially available coin-shaped primary and secondary batteries use a liquid electrolyte, which may leak out of the battery in some cases. Every liquid electrolyte is highly corrosive and many of them affect adversely to human body. Therefore, the leakage of the electrolyte must be prevented. In view of this, Japanese Laid-Open Patent Publication No. HEI10-247516 proposes an all solid battery using a solid electrolyte in place of the liquid electrolyte. According to this publication, a point of contact between the current collector and the electrode is movable, thereby reducing an increase in internal resistance through the repeated charge/discharge cycles. Further, the publication describes mesh, expanded metal, foam metal, wire, punched metal and fiber as recommended materials for the current collector.

With use of the structure for current collection according to Japanese Laid-Open Patent Publication No. HEI10-247516, the contact between the electrode and the case or the sealing plate can be maintained in the same state as that of the initial stage of charge/discharge even if the power generating unit varies in volume (expands) or thickness through the repeated charge/discharge cycles. However, since the contact area between the electrode and the mesh or expanded metal is limited, battery characteristics, especially high rate charge/discharge characteristic and active material utilization ratio, do not improve. Further, if the electrode is made of a powder compact, it is difficult to bond the electrode and the current collector firmly. Thereby, the battery life may possibly be unsatisfactory.

Japanese Laid-Open Patent Publication No. HEI10-247516 also proposes use of electron conductive rubber as the current collector. However, the electron conductive rubber needs to be thick to a certain degree to alleviate, by use of its elasticity, the variation in volume through the repeated charge/discharge cycles. In this case, the share of electrode volume in the whole battery volume decreases, which leads to a decrease in battery capacity.

### BRIEF SUMMARY OF THE INVENTION

An object of the present invention is to achieve one or more of the goals of: keeping internal resistance in a coin-shaped all solid battery, which is free from the risk of electrolyte leakage, smaller than that in a conventional battery; improving high rate charge/discharge characteristic and active material utilization ratio of the coin-shaped all solid battery; alleviating variations in high rate charge/discharge characteristic and active material utilization ratio; and prolonging the life of the coin-shaped all solid battery.

The present invention relates to a coin-shaped all solid battery comprising: (a) a power generating unit including a first electrode, a second electrode and a solid electrolyte interposed therebetween; (b) a metallic case facing to the first electrode to serve as a first electrode terminal; (c) a metallic sealing plate facing to the second electrode to serve as a second electrode terminal; (d) a gasket insulating the metallic case from the metallic sealing plate; and at least one of (e-1) a first conductive layer interposed between the first electrode and the metallic case to be integrated with the first electrode and (e-2) a second conductive layer interposed between the second electrode and the metallic sealing plate to be integrated with the second electrode, wherein the conductive layer comprises porous metal and said porous metal comprises a molded metal powder.

Specifically, the present invention relates to a coin-shaped all solid battery comprising: (a) a power generating unit including a positive electrode, a negative electrode and a solid electrolyte interposed therebetween; (b) either one of a metallic case and a metallic sealing plate to serve as a positive electrode terminal facing to the positive electrode; (c) the other one of the metallic case and the metallic sealing plate to serve as a negative electrode terminal facing to the negative electrode; (d) a gasket insulating the metallic case from the metallic sealing plate; and (e-1) a conductive layer A interposed between the positive electrode and either one of the metallic case and the metallic sealing plate to be integrated with the positive electrode, wherein the conductive layer A comprises porous metal and the porous metal comprises a molded metal powder.

Further, the present invention relates to a coin-shaped all solid battery comprising: (a) a power generating unit including a positive electrode, a negative electrode and a solid electrolyte interposed therebetween; (b) either one of a metallic case and a metallic sealing plate to serve as a positive electrode terminal facing to the positive electrode; (c) the other one of the metallic case and the metallic sealing plate to serve as a negative electrode terminal facing to the negative electrode; (d) a gasket insulating the metallic case from the metallic sealing plate; and (e-2) a conductive layer B interposed between the negative electrode and the other one of the metallic case and the metallic sealing plate to be integrated with the negative electrode, wherein the conductive layer B comprises porous metal and the porous metal comprises a molded metal powder.

Still further, the present invention relates to a coin-shaped all solid battery comprising: (a) a power generating unit including a positive electrode, a negative electrode and a solid electrolyte interposed therebetween; (b) either one of a metallic case and a metallic sealing plate to serve as a positive electrode terminal facing to the positive electrode; (c) the other one of the metallic case and the metallic sealing plate to serve as a negative electrode terminal facing to the negative electrode; (d) a gasket insulating the metallic case from the metallic sealing plate; (e-1) a conductive layer A interposed between the positive electrode and either one of the metallic case and the metallic sealing plate to be integrated with the positive electrode; and (e-2) a conductive layer B interposed between the negative electrode and the other one of the metallic case and the metallic sealing plate to be integrated with the negative electrode, wherein the conductive layers A and B comprise porous metal, respectively, and the porous metal comprises a molded metal powder.

The metal powder is preferably filamentary. That is, the metal powder preferably comprises primary particles linked in a form of filament.

The metal powder preferably comprises at least one selected from the group consisting of aluminum, titanium, iron, cobalt, nickel, copper, zinc, molybdenum, silver and an alloy containing at least one of these elements as a main component.

In particular, the metal powder preferably comprises nickel.

The conductive layer preferably covers 95% or more of a surface of the electrode integrated with the conductive layer on the conductive layer side.

The conductive layer more preferably covers an entire surface of the electrode integrated with the conductive layer on the conductive layer side.

The porous metal comprising the molded metal powder can be bonded firmly with the electrode and sufficiently conductive in the thickness direction. Accordingly, even if the conductive layer is in point contact with the case or the sealing plate, the internal resistance is reduced to a satisfactory degree. Further, when the electrode and the conductive layer are bonded at their entire surfaces facing to each other, the active material utilization rate is kept high with stability.

That is, the conductive layer preferably covers 95% or more of the surface of the electrode on the conductive layer side. It is most preferable that the conductive layer covers the entire surface of the electrode on the conductive layer side.

Thus, according to an embodiment of the present invention, internal resistance of the coin-shaped all solid battery free from the risk of electrolyte leakage is kept smaller than that of a conventional battery. Further, according to an embodiment of the present invention, the coin-shaped all solid battery improves in high rate charge/discharge characteristic and active material utilization ratio. Still further, according to an embodiment of the present invention, variations in high rate charge/discharge characteristic and active material utilization ratio are alleviated. Moreover, according to an embodiment of the present invention, the coin-shaped all solid battery improves in life. In addition, according to an embodiment of the present invention, a decrease in battery capacity, which occurs, for example, when electron conductive rubber is used as the current collector, is prevented.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a longitudinal section illustrating an example of a conventional coin-shaped battery.

FIG. 2 is a longitudinal section illustrating an example of a coin-shaped all solid battery according to the present invention.

FIG. 3 is a graph showing a relationship between charge/discharge cycle and discharge capacity with respect to an example of the coin-shaped all solid battery according to the present invention and a coin-shaped all solid battery of Comparative Example.

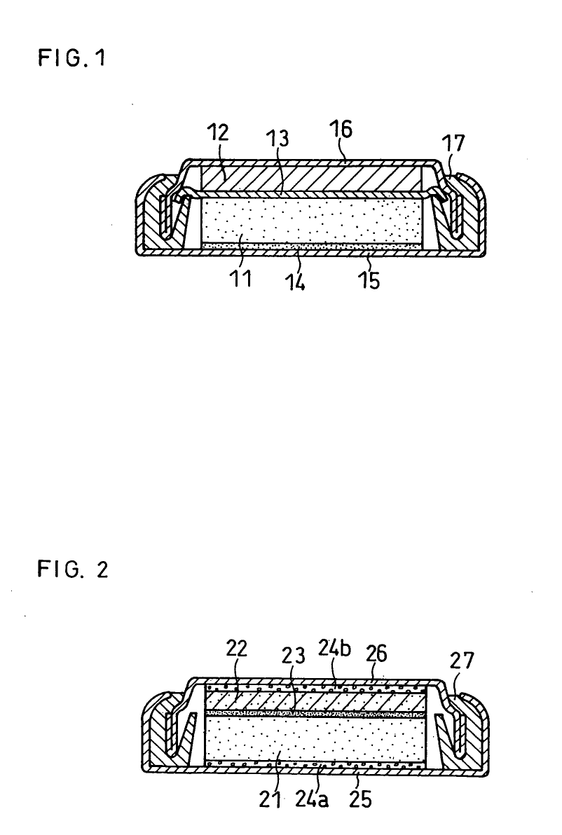

### DETAILED DESCRIPTION OF THE INVENTION

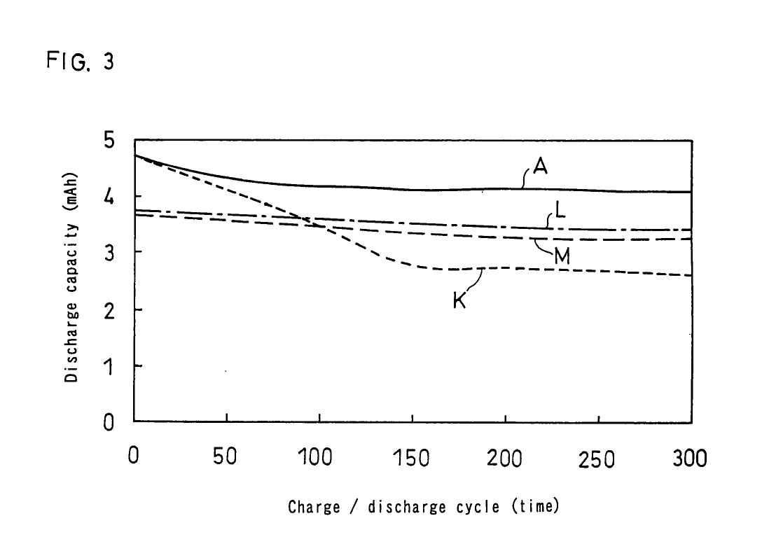

Hereinafter, explanation is given with reference to FIG. 2.

A power generating unit of an all solid battery according to the present invention includes a positive electrode, a negative electrode and a solid electrolyte interposed therebetween. The present invention is applicable to any coin-shaped batteries such as alkaline button batteries, lithium primary batteries and lithium ion secondary batteries. Therefore, composition, thickness and preparation process of the positive electrode, negative electrode and solid electrolyte may follow the conventional ones depending on the kind of intended battery.

For example, the positive and negative electrodes are made of certain active materials, respectively, to which a conductive agent or the like may be added as required. As required, the positive electrode, solid electrolyte and negative electrode may be added with a binder such as a silicone resin, styrene butadiene rubber (SBR) and butyl rubber, a release agent such as citrate and the like.

FIG. 2 is a longitudinal section of an all solid battery according to an embodiment of the present invention.

A positive electrode 21 is faced to a metallic case 25 serving as a positive electrode terminal, while a negative electrode 22 is opposed to a metallic sealing plate 26 serving as a negative electrode terminal. A solid electrolyte 23 serving as a separator is interposed between the positive electrode 21 and the negative electrode 22. The case 25 and the sealing plate 26 are insulated by a gasket 27. A conductive layer A 24a integrated with the positive electrode 21 is interposed between the positive electrode 21 and the case 25, while a conductive layer B 24b integrated with the negative electrode 22 is interposed between the negative electrode 22 and the sealing plate 26.

The conductive layers A and B are made of porous metal comprising a molded metal powder, respectively. The conductive layers A and B may be press-bonded to the surfaces of the positive electrode 21 and the negative electrode 22 opposite to the solid electrolyte 23, respectively. If necessary, a binder and a release agent may be added to each of the conductive layers.

The porous metal for forming the conductive layers preferably has porosity P (%) in the range of 0<P≦30. If the porosity is too high, the degree of bonding between the conductive layer and the electrode may possibly be lowered. However, even if the porosity is low, there is no particular problems as far as the porous metal has a burr, flash or a projection which can be engaged or embedded in the electrode. For example, if the porous metal is compression-molded together with the electrode, part of the porous metal may loose almost all of its porosity.

As the metal powder, for example, particulate (spherical, almost spherical, oval-shaped, indefinite-shaped or massive) metal powder having an average particle diameter of 0.1 to 150 μm may be used. The metal powder preferably comprises primary particles linked in the form of filament, for the filamentary metal powder can firmly be bonded with the positive and negative electrodes and has high formability. The filamentary metal powder preferably has an aspect ratio of 5 to 1,000 on average and an average fiber diameter of 0.1 to 150 μm. However, there is no particular limitation to the metal powder as long as the above-mentioned porosity is obtained.

The filamentary metal powder preferably comprises primary metal particles linked to form a three-dimensional chain network. It is particularly preferable that an average particle diameter of the primary particles is 0.5 to 3 μm.

A material for the metal powder is preferably at least one selected from the group consisting of aluminum, titanium, iron, cobalt, nickel, copper, zinc, molybdenum, silver and an alloy containing at least one of these elements as a main component (50 wt % or more). Further, it is preferable that the metal powder is inexpensive, not excessively ductile during molding, covered with a thin oxide film with stability, and causes less loads to the environment.

In view of these, particularly suitable metal powder is nickel powder such as carbonyl nickel powder. A certain kind of carbonyl nickel comprises primary particles of 0.5 to 3 μm in average particle diameter three-dimensionally linked in the filament form, which is easily available. For example, Type 255 sold by INCO may be used.

The conductive layer on the positive electrode and that on the negative electrode may or may not be made of the same porous metal comprising the molded metal powder. However, as the conductive layer on the negative electrode, it is desirable not to use a material that generates an intermetallic compound with lithium at a potential more noble than a negative electrode active material. Since an all solid battery does not contain a liquid electrolyte, even a metal which may possibly be oxidized by a positive electrode active material may be used as the conductive layer for the positive electrode as long as an insulative oxide coating film does not grow thereon.

The conductive layer comprising the porous metal comprising the molded metal powder preferably covers almost the entire surface (e.g., 90% or more or 95% or more) of the electrode which is not in contact with the solid electrolyte. The conductive layer is preferably 1 to 200 μm in thickness. If the conductive layer is too thick, the battery may decrease in capacity. On the other hand, if the conductive layer is too thin, it may become difficult to form the conductive layer having a uniform thickness.

### EXAMPLES

Hereinafter, the present invention is described in detail by way of examples.

### Example 1

As a positive electrode active material, a solid electrolyte and a negative electrode active material, LiCoO₂, a lithium ion conductive vitreous solid electrolyte represented by Li₃PO₄-63Li₂S-36SiS₂ and Li_{4/3}Ti_{5/3}O₄ were used, respectively. These powders were pulverized in advance using an agate mortar and a pestle.

(I) Positive Electrode Material Mixture

Using an agate mortar and a pestle, LiCoO₂ and the solid electrolyte were mixed together with ketjen black as a conductive agent and polytetrafluoroethylene (PTFE) as a binder in the ratio of 50/48/1/1 by weight to prepare a positive electrode material mixture.

(II) Negative Electrode Material Mixture

In a like manner, Li_{4/3}Ti_{5/3}O₄ and the solid electrolyte were mixed together with ketjen black and PTFE in the ratio of 50/48/1/1 in an agate mortar to prepare a negative electrode material mixture.

(III) Power Generating Unit

A power generating unit was formed in the following steps using a hollow main mold having a columnar cavity of 6.8 mm in diameter, a lower mold having a convex portion to be fitted in a lower portion of the cavity and an upper mold having a convex portion to be fitted in an upper portion of the cavity. Each of the convex portions had a flat top. The sum of the heights of the convex portions of the upper and lower molds is larger than the height of the columnar cavity of the main mold.

[a]With the convex portion of the lower mold inserted in the lower portion of the cavity, 10 mg of the solid electrolyte was placed in the cavity. Then, the convex portion of the upper mold was inserted in the upper portion of the cavity to compress the solid electrolyte.

[b] After the upper mold was pulled out, 55 mg of the negative electrode material mixture was put in the cavity. Then, the convex portion of the upper mold was inserted again in the cavity to compress the negative electrode material mixture.

[c] The upper mold was pulled out again, and then 5 mg of filamentary nickel powder (Type 255 manufactured by INCO, primary particle diameter: 2.2 to 2.8 μm, specific surface area: 0.7 m²/g, apparent density: 0.5 to 0.65 g/Cm³) was placed in the cavity. Then, the convex portion of the upper mold was inserted in the cavity to compress the nickel powder.

[d] With the upper mold kept fitted in the cavity, the main mold was turned upside down and the lower mold was pulled out. Then, 53 mg of the positive electrode material mixture was placed in the cavity and the convex portion of the lower mold was inserted in the cavity to compress the positive electrode material mixture.

[e] After the lower mold was pulled out, 5 mg of filamentary nickel powder (Type 255 manufactured by INCO) was put in the cavity. Then, the convex portion of the lower mold was inserted in the main mold to compress the nickel powder.

[f] With the lower mold kept fitted in the main mold, the main mold was turned upside down again. Then, pressure of 3×10⁸ Pa was applied between the upper and lower molds using a hydraulic press.

[g] The upper mold was pulled out and the main mold was turned upside down. Then, a cylindrical die was placed on the surface where the upper mold had been arranged and pressure was applied between the lower mold and the cylindrical die to extrude a pellet out of the main mold. Thus, a pellet comprising five layers, i.e., a nickel powder layer, a positive electrode material mixture layer, a solid electrolyte layer, a negative electrode material mixture layer and another nickel powder layer, was obtained.

(IV) Coin-Shaped Battery

The obtained pellet was placed in a case such that the nickel powder layer on the positive electrode side was in contact with the inner bottom surface of the case. Then, while pressing the nickel powder layer on the negative electrode side with an inner surface of a sealing plate, an opening end of the case was crimped to a gasket arranged around the periphery of the sealing plate. Thus, a coin-shaped all solid battery A was completed.

### Example 2

A coin-shaped all solid battery B was fabricated in the same manner as Example 1 except that the nickel powder Type 255 of INCO used in Example 1 was replaced with aluminum powder manufactured by Aldrich (particle diameter: 75 μm or smaller).

### Example 3

A coin-shaped all solid battery C was fabricated in the same manner as Example 1 except that the nickel powder Type 255 of INCO used in Example 1 was replaced with titanium powder manufactured by Aldrich (particle diameter: 45 μm or smaller).

### Example 4

A coin-shaped all solid battery D was fabricated in the same manner as Example 1 except that the nickel powder Type 255 of INCO used in Example 1 was replaced with iron powder manufactured by Aldrich (average particle diameter: 10 μm).

### Example 5

A coin-shaped all solid battery E was fabricated in the same manner as Example 1 except that the nickel powder Type 255 of INCO used in Example 1 was replaced with cobalt powder manufactured by Aldrich (particle diameter: 150 μm or smaller).

### Example 6

A coin-shaped all solid battery F was fabricated in the same manner as Example 1 except that the nickel powder Type 255 of INCO used in Example 1 was replaced with copper powder manufactured by Aldrich (particle diameter: 75 μm or smaller).

### Example 7

A coin-shaped all solid battery G was fabricated in the same manner as Example 1 except that the nickel powder Type 255 of INCO used in Example 1 was replaced with zinc powder manufactured by Aldrich (particle diameter: 150 μm or smaller).

### Example 8

A coin-shaped all solid battery H was fabricated in the same manner as Example 1 except that the nickel powder Type 255 of INCO used in Example 1 was replaced with molybdenum powder manufactured by Aldrich (particle diameter: 150 μm or smaller).

### Example 9

A coin-shaped all solid battery I was fabricated in the same manner as Example 1 except that the nickel powder Type 255 of INCO used in Example 1 was replaced with silver powder manufactured by Aldrich (particle diameter: 45 μm or smaller).

### Comparative Example 1

[a]With the convex portion of the lower mold fitted in the lower portion of the cavity, 10 mg of the solid electrolyte was placed in the cavity. Then, the convex portion of the upper mold was engaged in the cavity to compress the solid electrolyte.

[b] After the upper mold was pulled out, 55 mg of the negative electrode material mixture was placed in the cavity. Then, the convex portion of the upper mold was inserted in the cavity to compress the negative electrode material mixture.

[c] With the upper mold kept fitted in the cavity, the main mold was turned upside down and the lower mold was pulled out. Then, 53 mg of the positive electrode material mixture was placed in the cavity and the convex portion of the lower mold was inserted in the cavity to compress the positive electrode material mixture.

[d] With the lower mold kept fitted in the cavity, the main mold was turned upside down again. Then, pressure of 3×10⁸ Pa was applied between the upper and lower molds using a hydraulic press.

[e] In the same manner as Example 1, a pellet was extruded from the main mold. Thus, a pellet comprising three layers, i.e., a positive electrode material mixture layer, a solid electrolyte layer and a negative electrode material mixture layer, was formed.

[f] A paste containing natural graphite as a main component was applied to the inner surface of a metallic case serving as a positive electrode terminal and the inner surface of a metallic sealing plate serving as a negative electrode terminal, and then the paste was dried.

The paste used was composed of about 22 wt % of flaky natural graphite (average particle diameter: 5 μm), about 1 wt % of carboxymethyl cellulose, about 2 wt % of acrylic styrene resin, about 4.5 wt % of isopropylalcohol and water accounting for the rest. The dried paste was about 100 μm in thickness.

The extruded pellet was placed in a case such that the positive electrode was in contact with the inner bottom surface of the case. Then, while pressing the negative electrode with the inner surface of the sealing plate, an opening end of the case was crimped to a gasket arranged around the periphery of the sealing plate. Thus, a coin-shaped all solid battery J was completed.

Each of the batteries A to J had a theoretical capacity of 4.6 mAh and operating voltage of about 2 V. The batteries A to J were charged up to 3.3 V at 60 μA and discharged down to 1.0 V at 60 μA, respectively. Discharge capacities and average discharge voltages at that time are shown in Table 1.

TABLE 1

| | Discharge capacity | Average discharge |
|---|---|---|
| Battery | (mAh) | voltage (V) |
| A | 4.23 | 1.956 |
| B | 4.13 | 1.942 |
| C | 4.25 | 1.958 |
| D | 4.18 | 1.944 |
| E | 4.28 | 1.960 |
| F | 4.11 | 1.938 |
| G | 4.21 | 1.948 |
| H | 4.22 | 1.944 |
| I | 4.29 | 1.961 |
| J | 3.15 | 1.716 |

The results shown in Table 1 indicate that the batteries A to I, examples of the present invention, are higher in discharge capacity and average discharge voltage than the comparative battery J. Thus, it is ascertained that the present invention allows providing an all solid battery which is high in active material utilization ratio and low in internal resistance. The high average discharge voltage indicates that the internal resistance is small.

### Example 10

Then, morphology of the metal powder was studied.

A battery K was fabricated in the same manner as Example 1 except that the nickel powder Type 255 of INCO used in Example 1 was replaced with nickel powder manufactured by Aldrich (average particle diameter: 3 μm, massive form).

### Comparative Example 2

A battery L was fabricated in the same manner as Example 1 except that the nickel powder Type 255 of INCO used in Example 1 was replaced with nickel foam metal stamped into a 6 mm diameter disc (porosity 94%, 200 g/m²).

### Comparative Example 3

A battery M was fabricated in the same manner as Example 1 except that the nickel powder Type 255 of INCO used in Example 1 was replaced with a metal net made of stainless steel stamped into a 6 mm diameter disc (a 40 mesh net comprising stainless steel (SUS 304) wire of 160 μm in diameter).

In a 45° C. atmosphere, the batteries A, K, L and M were charged up to 3.3 V at 230 μA, respectively. Then, after a 30-minute rest, each of them was discharged down to 1.0 V at 230 μA and given the 30-minute rest again. The charge and discharge were repeated in this manner to observe variations in discharge capacity of the batteries. FIG. 3 shows the results.

As seen in FIG. 3, a decrease in discharge capacity through the charge/discharge cycles is smaller in the battery A than in the battery K, indicating that the battery A is superior in life. Since the battery A utilizes the filamentary nickel powder, firmer bond was established between the electrodes and the conductive layers. Therefore, it is assumed that the bond was maintained even if the active material varied in volume through the charge/discharge cycles. On the other hand, in the battery K using the massive nickel powder, it is considered that the bond between the electrodes and the conductive layers was not so secure and weakened through the charge/discharge cycles. Therefore, the current collecting capability was reduced as compared with the battery A.

Further, the battery A was revealed to have higher discharge capacity than the discharge capacities of the batteries L and M. Since the conductive layer comprising the molded metal powder was larger than the foamed metal and the metal net in bonding area with the electrode comprising the electrode material mixture, it is assumed that the active material utilization ratio in the battery A improved as compared with the batteries L and M.

Thus, according to the present invention, the electrode and the conductive layer are firmly bonded, thereby a battery excellent in charge/discharge cycle characteristic is provided.

The present invention is applicable to: a coin-shaped all solid battery which is free from the risk of electrolyte leakage and has internal resistance lowered as compared with a conventional battery; a coin-shaped all sold battery improved in high rate charge/discharge characteristic and active material utilization ratio as compared with a conventional battery; a coin-shaped all solid battery in which variations in high rate charge/discharge characteristic and active material utilization ratio are alleviated as compared with a conventional battery; and a coin-shaped all solid battery improved in battery life as compared with a conventional battery.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A coin-shaped all solid battery comprising:
(a) a power generating unit including a first electrode, a second electrode and a solid electrolyte interposed therebetween;
(b) a metallic case facing to said first electrode to serve as a first electrode terminal;
(c) a metallic sealing plate facing to said second electrode to serve as a second electrode terminal;
(d) a gasket insulating said metallic case from said metallic sealing plate; and
at least one of (e-1) a first conductive layer interposed between said first electrode and said metallic case to be integrated with said first electrode and (e-2) a second conductive layer interposed between said second electrode and said metallic sealing plate to be integrated with said second electrode,
wherein said conductive layer comprises porous metal and said porous metal comprises a molded metal powder.

2. The coin-shaped all solid battery in accordance with claim 1, wherein said metal powder comprises primary particles linked in a form of filament.

3. The coin-shaped all solid battery in accordance with claim 1, wherein said porous metal comprises at least one selected from the group consisting of aluminum, titanium, iron, cobalt, nickel, copper, zinc, molybdenum, silver and an alloy containing at least one of these elements as a main component.

4. The coin-shaped all solid battery in accordance with claim 1, wherein said conductive layer covers 95% or more of a surface of said electrode integrated with the conductive layer on the conductive layer side.

5. The coin-shaped all solid battery in accordance with claim 1, wherein said conductive layer covers an entire surface of said electrode integrated with the conductive layer on the conductive layer side.
